(19) United States
(12) Patent Application Publication
(10) Pub. No.: US 2022/0381910 A1
(43) Pub. Date: Dec. 1, 2022

(54) IRRADIATION APPARATUS

(71) Applicant: HONDA MOTOR CO.,LTD., Tokyo (JP)

(72) Inventor: Yuichi HIDAKA, Saitama (JP)

(21) Appl. No.: 17/748,005

(22) Filed: May 18, 2022

(30) Foreign Application Priority Data
May 27, 2021 (JP) 2021-089454

(51) Int. Cl. G01S 17/06; G01S 7/481; H02S 10/40; H02S 40/22; H02S 40/38; H02J 7/35; B60L 53/37

(52) U.S. Cl. CPC G01S 17/06; G01S 7/4814; G01S 7/4816; H02S 10/40; H02S 40/22; H02S 40/38; H02J 7/35; B60L 53/37

(57) ABSTRACT

An irradiation apparatus may include: an irradiation unit configured to emit a light beam toward a photoelectric conversion unit of a vehicle, the photoelectric conversion unit being configured to convert light energy into electric energy to charge the power storage unit; an adjustment mechanism configured to adjust at least one of a position or a posture of at least one of the irradiation unit or the vehicle; a detector including a light receiving unit configured to receive reflected light of the light beam, and configured to detect a positional relationship between the photoelectric conversion unit and the irradiation unit based on a light receiving result of the reflected light by the light receiving unit; and a controller configured to control the adjustment mechanism based on a detection result of the detector so that the positional relationship between the photoelectric conversion unit and the irradiation unit becomes a predetermined positional relationship.

### BACKGROUND

### 1. Technical Field

The present invention relates to an irradiation apparatus.

### 2. Related Art

The contents of the following Japanese patent application(s) are incorporated herein by reference:

NO. 2021-089454 filed in JP on May 27, 2021

Patent Document 1 discloses moving at least one of a charging apparatus or a vehicle to control the charging operation of the charging apparatus.

### PRIOR ART DOCUMENT

### Patent Document

Patent Document 1: International Publication No. 2017/159506

### BRIEF DESCRIPTION OF THE DRAWINGS

FIG. 1 schematically shows an overall configuration of a charging system.

FIG. 2 is a schematic view seen from a laser beam output surface side of a transmitter.

FIG. 3 is a schematic view seen from a light receiving surface side of a PV panel.

FIG. 4 shows an example of functional blocks of an irradiation apparatus.

FIG. 5 shows an example of the positional relationship between the PV panel and the transmitter.

FIG. 6 shows an example of the positional relationship between the PV panel and the transmitter.

FIG. 7 shows an example of the positional relationship between the PV panel and the transmitter.

FIG. 8 shows an example of the positional relationship between the PV panel and the transmitter.

FIG. 9 shows an example of a procedure to start charging a battery of a vehicle by causing the PV panel of the vehicle to generate electric power with a laser beam emitted by the irradiation apparatus.

FIG. 10 schematically shows an example of an overall configuration of a charging system.

### DESCRIPTION OF EXEMPLARY EMBODIMENTS

Hereinafter, the present invention will be described through embodiments of the invention; however, the following embodiments do not limit the claimed inventions. Moreover, not all combinations of features described in the embodiments are essential to the solutions of the invention.

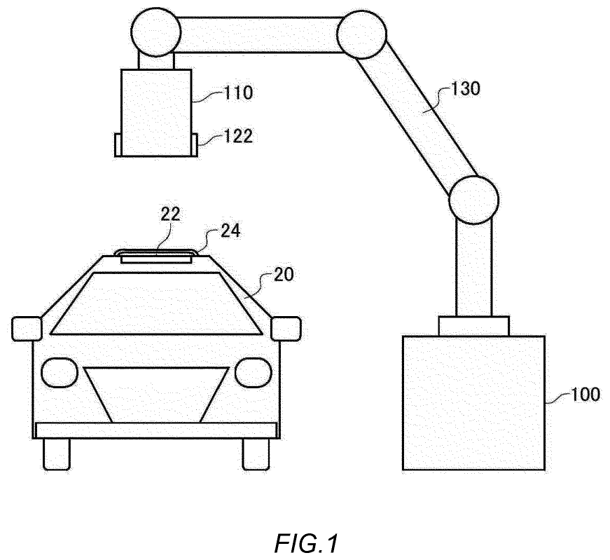

FIG. 1 schematically shows an overall configuration of a charging system. A vehicle 20 is equipped with a battery. The battery is an example of a power storage unit. The vehicle 20 may be a hybrid vehicle or an electric vehicle. The vehicle 20 includes a PV panel 22 for charging the battery. The PV panel 22 is a solar panel and is an example of a photoelectric conversion unit for converting light energy into electric energy to charge the battery. The vehicle 20 further includes a reflection plate 24 arranged to at least partly overlap an edge of a light receiving surface of the PV panel 22.

The irradiation apparatus 100 includes a transmitter 110, a plurality of light receivers 122, and an adjustment mechanism 130. The irradiation apparatus 100 may be provided in a space where the vehicle 20 can stop. The irradiation apparatus 100 may be provided adjacent to a parking space of the vehicle 20. The transmitter 110 emits a light beam toward the PV panel 22. The transmitter 110 may emit a laser beam toward the PV panel 22. The transmitter 110 may emit a near-infrared laser beam. The transmitter 110 may emit a laser beam vertically downward toward the light receiving surface of the PV panel 22 provided on the top of the vehicle 20.

Each of the plurality of light receivers 122 is provided around the transmitter 110, and receives reflected light emitted from the transmitter 110 and reflected by the PV panel 22, the reflection plate 24, and the like. The light receiver 122 is an optical sensor for detecting a received light amount.

The adjustment mechanism 130 holds the transmitter 110. The adjustment mechanism 130 adjusts at least one of the position or posture of the transmitter 110. The adjustment mechanism 130 three-dimensionally adjusts the position of the transmitter 110. The adjustment mechanism 130 adjusts the vertical and horizontal positions of the transmitter 110. The adjustment mechanism 130 adjusts the emission direction of the laser beam of the transmitter 110.

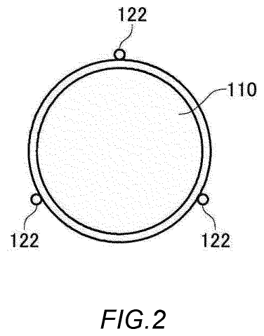

FIG. 2 is a schematic view seen from a laser beam output surface side of the transmitter 110. The plurality of light receivers 122 are arranged around the output surface of the transmitter 110. The plurality of light receivers 122 may be arranged radially around the output surface of the transmitter 110.

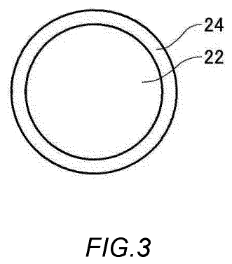

FIG. 3 is a schematic view seen from the light receiving surface side of the PV panel 22. The reflection plate 24 is arranged to surround the edge of the light receiving surface of the PV panel 22. The reflection plate 24 may partly overlap the light receiving surface of the PV panel 22 in a direction perpendicular to the light receiving surface of the PV panel 22. The reflection plate 24 may be convex toward the outside of the edge of the light receiving surface of the PV panel 22. Since the reflective surface of the reflection plate 24 has a convex shape, the laser beam of the transmitter 110 reflected by the reflective surface of the reflection plate 24 is easily diffused.

The irradiation apparatus 100 adjusts the position and posture of the transmitter 110 via the adjustment mechanism 130 so that the positional relationship between the PV panel 22 and the transmitter 110 becomes a predetermined positional relationship based on a light receiving result of reflected light by the light receiver 122. The predetermined positional relationship is a positional relationship in which the laser beam emitted from the transmitter 110 is efficiently applied to the PV panel 22 so that the PV panel 22 can efficiently generate electric power. The predetermined positional relationship may be determined based on a measurement result of the power generation efficiency of the PV panel 22 by a demonstration experiment.

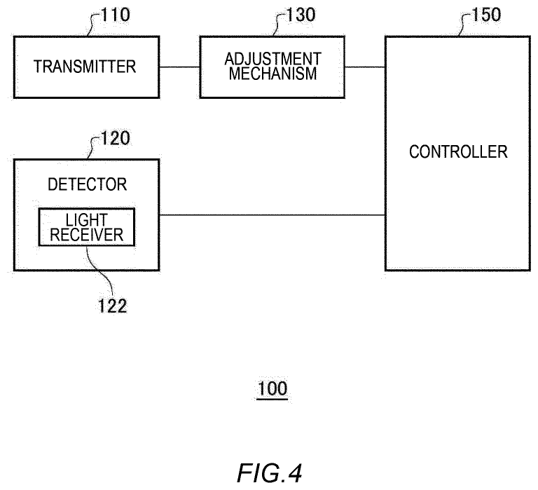

FIG. 4 shows an example of functional blocks of the irradiation apparatus 100. The irradiation apparatus 100 includes a transmitter 110, a detector 120, an adjustment mechanism 130, and a controller 150. The detector 120 includes a light receiver 122. The detector 120 may include a plurality of light receivers 122. The detector 120 detects the positional relationship between the PV panel 22 and the transmitter 110 based on the light receiving result of the reflected light by the light receiver 122. The detector 120 may detect the positional relationship between the PV panel 22 and the transmitter 110 based on the received light amount of reflected light received at the light receiver 122.

The transmitter 110 may emit a pulse laser beam toward the PV panel 22 to cause the detector 120 to detect the positional relationship between the PV panel 22 and the transmitter 110. The detector 120 may detect the time from when a pulse laser beam is emitted from the transmitter 110 to when reflected light of the pulse laser beam is received at the light receiver 122, and detect the positional relationship between the PV panel 22 and the transmitter 110 based on the detected time.

Based on the detection result of the detector 120, the controller 150 controls the adjustment mechanism 130 so that the positional relationship between the PV panel 22 and the transmitter 110 becomes a predetermined positional relationship. The controller 150 may perform an adjustment based on the light receiving results of reflected light received respectively by a plurality of light receivers 122 so that the positional relationship between the PV panel 22 and the transmitter 110 becomes the predetermined positional relationship.

The transmitter 110 may output a light beam with a first power (W) to cause the detector 120 to detect the positional relationship between the PV panel 22 and the transmitter 110. After the positional relationship between the PV panel 22 and the transmitter 110 becomes the predetermined positional relationship by the control of the adjustment mechanism 130 by the controller 150, the transmitter 110 may output a laser beam with a second power (W) greater than the first power to cause the PV panel 22 to charge the battery.

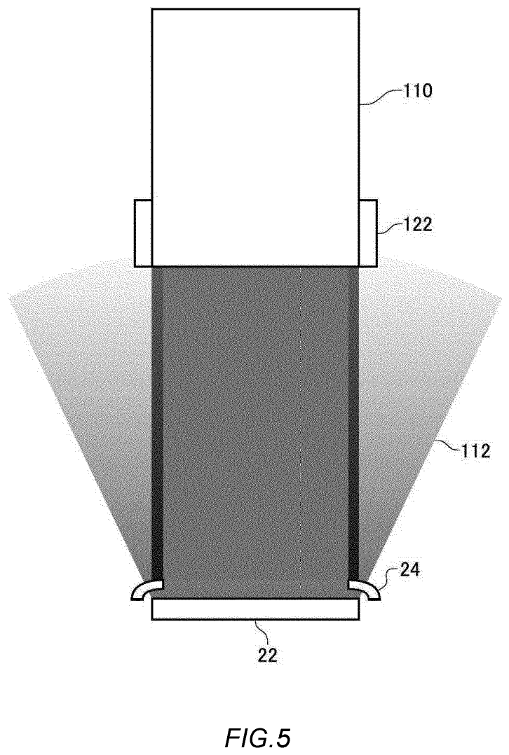

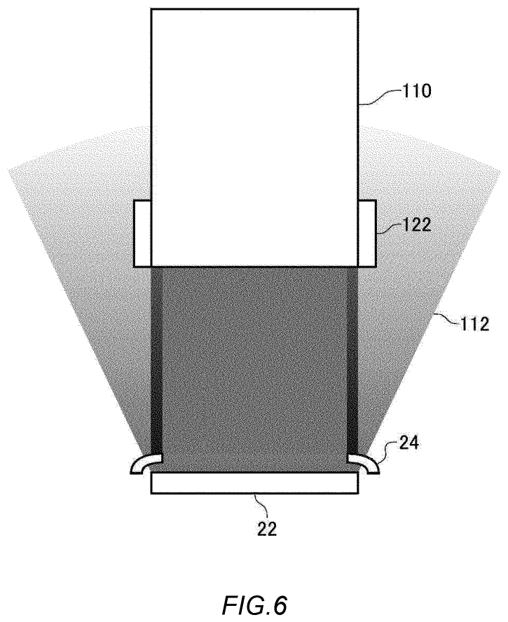

FIGS. 5, 6, 7, and 8 show examples of the positional relationship between the PV panel 22 and the transmitter 110. The distance between the PV panel 22 and the transmitter 110 shown in FIG. 6 is shorter than the distance between the PV panel 22 and the transmitter 110 shown in FIG. 5. As shown in FIG. 5, when the distance between the PV panel 22 and the transmitter 110 is long, the diffusion of reflected light 112 of the laser beam emitted from the transmitter 110 is large, and the received light amount of reflected light 112 received at the light receiver 122 is small. On the other hand, as shown in FIG. 6, when the distance between the PV panel 22 and the transmitter 110 is short, the diffusion of reflected light 112 of the laser beam emitted from the transmitter 110 is small, and the received light amount of reflected light 112 received at the light receiver 122 is large. That is, the distance between the PV panel 22 and the transmitter 110 can be estimated based on the received light amount of reflected light received at the light receiver 122.

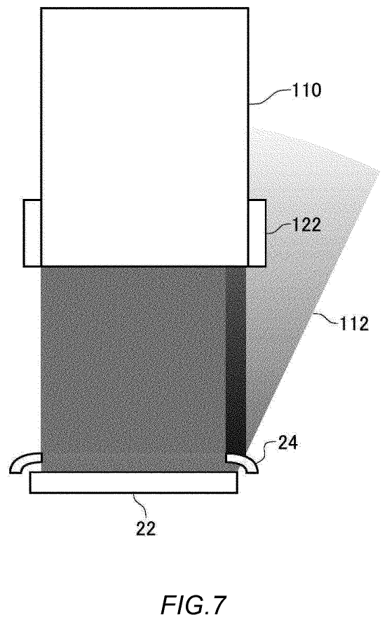

As shown in FIG. 7, when the transmitter 110 is displaced in the horizontal direction with respect to the PV panel 22, the light receiving state of reflected light 112 of a plurality of light receivers 122 changes. For example, some of the plurality of light receivers 122 receive a first received light amount of reflected light 112, and the rest of the plurality of light receivers 122 receive a second received light amount of reflected light 112, which is smaller than the first received light amount. Alternatively, some of the plurality of light receivers 122 receive reflected light 112, and the rest of the plurality of light receivers 122 receive no reflected light 112.

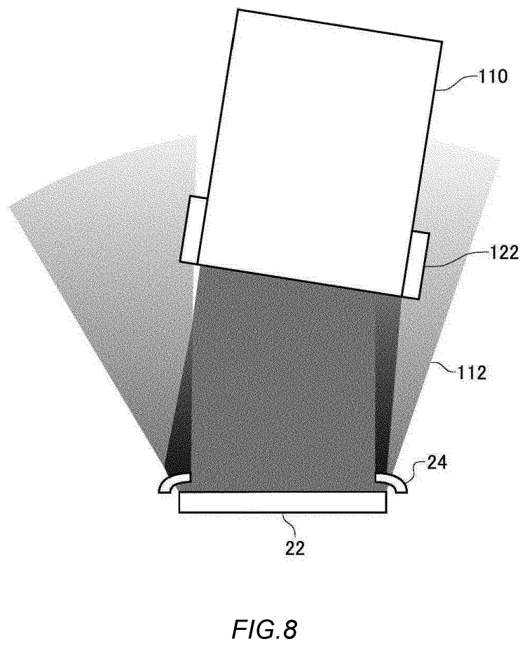

Furthermore, as shown in FIG. 8, when the transmitter 110 is inclined with respect to the PV panel 22, the light receiving state of reflected light 112 of a plurality of light receivers 122 changes. For example, some of the plurality of light receivers 122 receive a first received light amount of reflected light 112, and the rest of the plurality of light receivers 122 receive a second received light amount of reflected light 112, which is smaller than the first received light amount.

As described above, the difference in the positional relationship between the PV panel 22 and the transmitter 110 changes the light receiving state of reflected light of a plurality of light receivers 122. The controller 150 controls the adjustment mechanism 130 to adjust the positional relationship between the PV panel 22 and the transmitter 110 so that the light receiving state of reflected light of the plurality of light receivers 122 becomes a predetermined light receiving state.

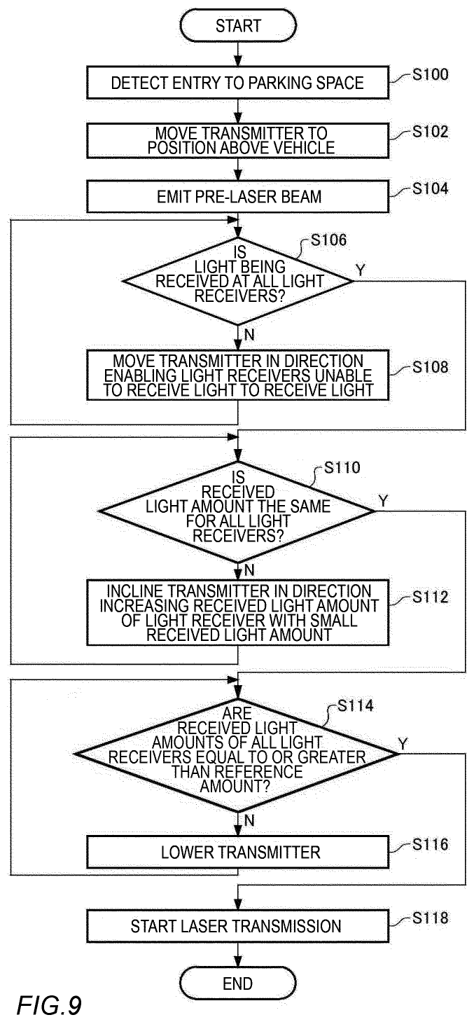

FIG. 9 shows an example of a procedure to start charging the battery of the vehicle 20 by causing the PV panel 22 of the vehicle 20 to generate electric power with a laser beam emitted by the irradiation apparatus 100.

The irradiation apparatus 100 detects that the vehicle 20 has entered a predetermined parking space (S100). The irradiation apparatus 100 may detect whether or not the vehicle 20 has entered the predetermined parking space based on a detection result from a detection sensor for detecting an object provided in the parking space.

When it is detected that the vehicle 20 has entered the predetermined parking space, the controller 150 controls the adjustment mechanism 130 to move the transmitter 110 to a position above the vehicle 20. The controller 150 may move the transmitter 110 to a position above the vehicle 20 by controlling the adjustment mechanism 130 to move the transmitter 110 to a predetermined position. The controller 150 may identify the vehicle type of the vehicle 20 and control the adjustment mechanism 130 to move the transmitter 110 to a predetermined position according to the vehicle type. The controller 150 may identify the vehicle type of the vehicle 20 by acquiring vehicle information indicating the vehicle type from the vehicle 20 via a network. The controller 150 may identify the vehicle type of the vehicle 20 based on an image of the vehicle 20 picked up by an image pickup apparatus provided in the parking space.

When the transmitter 110 moves to a position above the vehicle 20, the transmitter 110 emits a pre-laser beam toward the PV panel 22 (S102). The transmitter 110 may emit, toward the PV panel 22, a laser beam having a power weaker than the power emitted to cause the PV panel 22 to generate electric power.

Next, the controller 150 determines whether or not reflected light of the pre-laser beam of the transmitter 110 is being received at all the light receivers 122 (S106). When not all the light receivers 122 are able to receive the reflected light, the controller 150 controls the adjustment mechanism 130 to move the transmitter 110 in a direction enabling the light receivers 122 unable to receive the reflected light to receive the reflected light (step 108).

When all the light receivers 122 become able to receive the reflected light, the controller 150 determines whether or not the received light amount of reflected light of the pre-laser beam of the transmitter 110 is the same for all the light receivers 122 (5110). If the difference in the received light amount of reflected light of the pre-laser beam of the transmitter 110 between all the light receivers 122 falls within a predetermined range, the controller 150 may determine that the received light amount of reflected light is the same for all the light receivers 122.

When the received light amount of reflected light is not the same for all the light receivers 122, the controller 150 controls the adjustment mechanism 130 to incline the transmitter 110 in a direction increasing the received light amount of a light receiver 122 with a small received light amount (S112).

When the received light amount of reflected light is the same for all the light receivers 122, the controller 150 determines whether or not the received light amounts of all the light receivers 122 are equal to or greater than a reference amount (S114). If the received light amounts of all the light receivers 122 are less than the reference amount, the controller 150 controls the adjustment mechanism 130 to move the transmitter 110 vertically downward in order to bring the transmitter 110 closer to the PV panel 22 (S116).

When the received light amounts of all the light receivers 122 become equal to or greater than the reference amount, the controller 150 determines that the positional relationship between the PV panel 22 and the transmitter 110 has become the predetermined positional relationship, completes the adjustment of the position and posture of the transmitter 110, and starts laser transmission by the transmitter 110 (S118). That is, the controller 150 emits a laser beam having a higher power than the pre-laser beam toward the PV panel 22.

As described above, the irradiation apparatus 100 emits a pre-laser beam toward the PV panel 22 through the transmitter 110, grasps the positional relationship between the PV panel 22 and the transmitter 110 based on the received light amount of the reflected light, adjusts the position and posture of the transmitter 110 so that the positional relationship between the PV panel 22 and the transmitter 110 becomes a predetermined positional relationship, and then starts laser power transmission by the transmitter 110. Accordingly, the adjustment of the positional relationship between the PV panel 22 and the transmitter 110 can be performed accurately, and power generation of the PV panel 22 can be performed efficiently with the laser beam from the transmitter 110.

The transmitter 110 may emit a pulse laser beam toward the PV panel 22 as a pre-laser beam. In this case, the controller 150 may identify the positional relationship between the PV panel 22 and the transmitter 110 based on the time from when the pulse laser beam is emitted from the transmitter 110 to when the pulse laser beam is received at the light receiver 122. The controller 150 may control the adjustment mechanism 130 to adjust the position and posture of the transmitter 110 so that the respective times at all the light receivers 122 from the time when the pulse laser beam is emitted from the transmitter 110 to the time when the pulse laser beam is received are the same or fall within a predetermined time range.

It should be noted that, when the transmitter 110 emits a pulse laser beam toward the PV panel 22 as a pre-laser beam, the reflection plate 24 may not be provided around the light receiving surface of the PV panel 22.

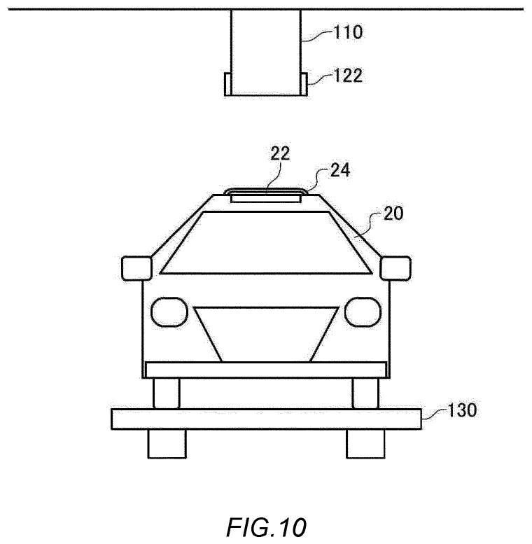

Described above is an example in which the positional relationship between the PV panel 22 and the transmitter 110 is adjusted by adjusting the position and posture of the transmitter 110. However, for example, as shown in FIG. 10, the adjustment mechanism 130 may be a mechanism for adjusting the height and inclination of a base on which the vehicle 20 is placed. The irradiation apparatus 100 may adjust the positional relationship between the PV panel 22 and the transmitter 110 by adjusting the position and posture of the vehicle 20 via the adjustment mechanism 130. The positional relationship between the PV panel 22 and the transmitter 110 may be adjusted by adjusting the position and posture of the transmitter 110 and the position and posture of the vehicle 20.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

20: vehicle; 22: PV panel; 24: reflection plate; 100: irradiation apparatus; 110: transmitter; 120: detector; 122: light receiver; 130: adjustment mechanism; 150: controller

What is claimed is:

1. An irradiation apparatus comprising:
an irradiation unit configured to emit a light beam toward a photoelectric conversion unit of a vehicle, the vehicle including a power storage unit and the photoelectric conversion unit, the photoelectric conversion unit being configured to convert light energy into electric energy to charge the power storage unit;
an adjustment mechanism configured to adjust at least one of a position or a posture of at least one of the irradiation unit or the vehicle;
a detector including a light receiving unit configured to receive reflected light of a light beam emitted by the irradiation unit, and configured to detect a positional relationship between the photoelectric conversion unit and the irradiation unit based on a light receiving result of the reflected light by the light receiving unit; and
a controller configured to control the adjustment mechanism based on a detection result of the detector so that the positional relationship between the photoelectric conversion unit and the irradiation unit becomes a predetermined positional relationship.

2. The irradiation apparatus according to claim 1, wherein
the detector includes a plurality of the light receiving units arranged around a light beam output surface of the irradiation unit, and
the controller is configured to control the adjustment mechanism based on light receiving results of the reflected light received respectively by the plurality of light receiving units so that the positional relationship between the photoelectric conversion unit and the irradiation unit becomes a predetermined positional relationship.

3. The irradiation apparatus according to claim 1, wherein the detector is configured to detect the positional relationship between the photoelectric conversion unit and the irradiation unit based on a received light amount of the reflected light received at the light receiving unit.

4. The irradiation apparatus according to claim 2, wherein the detector is configured to detect the positional relationship between the photoelectric conversion unit and the irradiation unit based on a received light amount of the reflected light received at the light receiving unit.

5. The irradiation apparatus according to claim 3, wherein
the irradiation unit is configured to:
output a light beam with a first power to cause the detector to detect the positional relationship between the photoelectric conversion unit and the irradiation unit; and
after the positional relationship between the photoelectric conversion unit and the irradiation unit becomes the predetermined positional relationship by control of the adjustment mechanism by the controller, output a light beam with a second power greater than the first power to cause the photoelectric conversion unit to charge the power storage unit.

6. The irradiation apparatus according to claim 1, wherein the irradiation unit emits a laser beam toward the photoelectric conversion unit.

7. The irradiation apparatus according to claim 2, wherein the irradiation unit emits a laser beam toward the photoelectric conversion unit.

8. The irradiation apparatus according to claim 3, wherein the irradiation unit emits a laser beam toward the photoelectric conversion unit.

9. The irradiation apparatus according to claim 5, wherein the irradiation unit emits a laser beam toward the photoelectric conversion unit.

10. The irradiation apparatus according to claim 1, wherein
the irradiation unit is configured to emit a pulse laser beam toward the photoelectric conversion unit to cause the detector to detect the positional relationship between the photoelectric conversion unit and the irradiation unit, and
the controller is configured to control the adjustment mechanism based on a time from when the pulse laser beam is emitted from the irradiation unit to when reflected light of the pulse laser beam is received by the light receiving unit so that the positional relationship between the photoelectric conversion unit and the irradiation unit becomes a predetermined positional relationship.

11. The irradiation apparatus according to claim 2, wherein
the irradiation unit is configured to emit a pulse laser beam toward the photoelectric conversion unit to cause the detector to detect the positional relationship between the photoelectric conversion unit and the irradiation unit, and
the controller is configured to control the adjustment mechanism based on a time from when the pulse laser beam is emitted from the irradiation unit to when reflected light of the pulse laser beam is received by the light receiving unit so that the positional relationship between the photoelectric conversion unit and the irradiation unit becomes a predetermined positional relationship.

12. The irradiation apparatus according to claim 1, wherein
the adjustment mechanism holds the irradiation unit such that the position and the posture of the irradiation unit are adjustable, and
the controller is configured to control the adjustment mechanism based on the light receiving result of the reflected light by the light receiving unit to adjust the position and the posture of the irradiation unit so that the positional relationship between the photoelectric conversion unit and the irradiation unit becomes the predetermined positional relationship.

13. The irradiation apparatus according to claim 2, wherein
the adjustment mechanism holds the irradiation unit such that the position and the posture of the irradiation unit are adjustable, and
the controller is configured to control the adjustment mechanism based on the light receiving result of the reflected light by the light receiving unit to adjust the position and the posture of the irradiation unit so that the positional relationship between the photoelectric conversion unit and the irradiation unit becomes the predetermined positional relationship.

14. The irradiation apparatus according to claim 3, wherein
the adjustment mechanism holds the irradiation unit such that the position and the posture of the irradiation unit are adjustable, and
the controller is configured to control the adjustment mechanism based on the light receiving result of the reflected light by the light receiving unit to adjust the position and the posture of the irradiation unit so that the positional relationship between the photoelectric conversion unit and the irradiation unit becomes the predetermined positional relationship.

15. The irradiation apparatus according to claim 5, wherein
the adjustment mechanism holds the irradiation unit such that the position and the posture of the irradiation unit are adjustable, and
the controller is configured to control the adjustment mechanism based on the light receiving result of the reflected light by the light receiving unit to adjust the position and the posture of the irradiation unit so that the positional relationship between the photoelectric conversion unit and the irradiation unit becomes the predetermined positional relationship.

16. The irradiation apparatus according to claim 1, wherein the light receiving unit is configured to receive reflected light emitted by the irradiation unit and reflected by a reflection unit arranged to at least partly overlap an edge of a light receiving surface of the photoelectric conversion unit of the vehicle.

17. The irradiation apparatus according to claim 2, wherein the light receiving unit is configured to receive reflected light emitted by the irradiation unit and reflected by a reflection unit arranged to at least partly overlap an edge of a light receiving surface of the photoelectric conversion unit of the vehicle.

18. The irradiation apparatus according to claim 16, wherein the light receiving unit is configured to receive reflected light emitted by the irradiation unit and reflected by the reflection unit to an outside of the edge of the light receiving surface, the reflection unit being convex.

19. The irradiation apparatus according to claim 1, wherein the irradiation unit is configured to emit a light beam vertically downward toward a light receiving surface of the photoelectric conversion unit provided on a top of the vehicle.

20. The irradiation apparatus according to claim 2, wherein the irradiation unit is configured to emit a light beam vertically downward toward a light receiving surface of the photoelectric conversion unit provided on a top of the vehicle.
